(19) United States
(12) Patent Application Publication
(10) Pub. No.: US 2010/0011558 A1
(43) Pub. Date: Jan. 21, 2010

(54) SYSTEMS AND METHODS FOR MANUFACTURING A CARRIAGE STYLE SECTIONAL DOOR

(76) Inventor: Robert Scott, Lehi, UT (US)

Correspondence Address: David B. Tingey, 1800 Eagle Gate Tower, 60 East South Temple, Salt Lake City, UT, 84145, US

(21) Appl. No.: 12/502,886

(22) Filed: Jul. 14, 2009

Related U.S. Application Data
(60) Provisional application No. 61/080,682, filed on Jul. 14, 2008.

(51) Int. Cl. B23P 11/00

(52) U.S. Cl. 29/428

(57) ABSTRACT

Systems and methods for manufacturing carriage house style sectional doors. A plurality of fabricated door sections, each section having a length that spans the garage opening. Each section includes an upper molding, a lower molding, and a paneled skin interposed between the upper and lower moldings. Each section is separately fabricated and then hingedly attached to an adjacent section via a plurality of hinges. The paneled skin is fabricated by bending a piece of sheet metal to provide a plurality of alternating raised and recessed surfaces. The paneled skin further includes features for coupling an upper and lower end of the paneled skin to the upper and lower moldings. Once completed, the hinged door sections are installed to selectively cover the garage opening. In yet another embodiment, a raised surface of the paneled skin creates a cavity into which a finger guard is inserted.

### CROSS-REFERENCE TO RELATED APPLICATION

This application claims priority to U.S. Provisional Patent Application Ser. No. 61/080,682, filed Jul. 14, 2008, and entitled METHOD OF MANUFACTURING A CARRIAGE STYLE SECTIONAL DOOR, which is incorporated herein in its entirety by reference.

### BACKGROUND OF THE INVENTION

1. Field of the Invention

The present invention relates to systems and methods for manufacturing overhead, sectional doors. Specifically, the present invention relates to methods for manufacturing wood style carriage house sectional doors from steel or other metal coil.

2. Background and Related Art

Sectional doors are commonly referred to as “overhead doors” or “garage doors,” and are designated by such names by reason of their operation. Sectional doors are designed to selectively provide closure for a garage opening, such as an automotive garage opening associated with a home. In order to accommodate the closure of the opening, the sectional door is typically assembled from a plurality of horizontally oriented door sections having a length that spans the door opening.

Current esthetic trends in sectional doors seek to mimic a carriage house door, which resembles a barn door style of the 19^{th} Century that has the appearance of swinging open. While methods and procedures currently exist to manufacture carriage house sectional doors from wood and extruded aluminum, these materials are costly and require extensive manual labor to produce quality sectional doors.

Thus, while techniques currently exist that are used to manufacture a variety of sectional doors, challenges still exist. Accordingly, it would be an improvement in the art to augment or even replace current techniques with other techniques.

### SUMMARY OF THE INVENTION

The present invention relates to systems and methods for manufacturing overhead, sectional doors. Specifically, the present invention relates to methods for manufacturing wood style carriage house sectional doors from steel or other metal coil.

Implementation of the present invention provides a multi-step method for manufacturing a carriage house style sectional door from sheet or coiled metal. The sheet or coiled metal is 24 or 26 gauge steel; however one of skill in the art will appreciate that other gauges of steel can be used within the scope of this invention. The method includes fabricating a plurality of door sections, each section having a length that spans the garage door opening. Each section is separately fabricated and then hingedly attached to an adjacent section via a plurality of hinges. Once completed, the hinged door sections are installed to selectively cover the garage opening.

Each section includes a minimum of three components, namely an upper molding, a lower molding, and a paneled skin interposed between the upper and lower moldings. The paneled skin is fabricated by bending a piece of sheet metal to provide a plurality of alternating raised and recessed surfaces. The paneled skin further includes features for coupling an upper and lower end of the paneled skin to the upper and lower moldings. For example, in one embodiment a recessed surface of the paneled skin includes a lip for engaging a mounting channel of the upper and lower moldings. In another embodiment, a raised surface of the paneled skin includes a flange that is coupled to a mounting surface of the upper and lower moldings. In yet another embodiment, a raised surface of the paneled skin creates a cavity into which a finger guard is inserted.

The upper and lower moldings are linear components of the sectional door that frame the upper and lower ends of the paneled skin. The upper and lower moldings are fabricated by bending pieces of sheet or coiled metal to a desired shape and length, as required by the sectional door. Each molding further includes a mounting surface and a mounting channel for coupling respective features of the paneled skin. Following fabrication, the components of the individual panels are assembled and then permanently coupled together. In one embodiment, the lip and the mounting channel are compressed and bent to approximately 45° thereby locking together the two features. In another embodiment, the flange and the mounting surface are coupled together via a hemming, rivet and/or spot weld process.

While the methods and processes of the present invention have proven to be particularly useful in the area of fabricating sectional doors, those skilled in the art will appreciate that the methods and processes can be used in a variety of different applications and in a variety of different areas of manufacture to yield similarly configured doors.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 is a perspective view of a representative embodiment of the present invention;

FIG. 2 is a perspective view of a representative embodiment of a concealed joint of a carriage style sectional door;

FIG. 3 is an exploded, perspective view of a representative embodiment of the concealed joint of FIG. 2;

FIG. 4 is an exploded, perspective view of the concealed joint end stile of FIG. 3;

FIG. 5 is perspective, rear view of a representative embodiment of a paneled skin;

FIG. 6 is a cross-sectioned side view of an upper and lower molding representing an embodiment of a concealed joint;

FIG. 7 is a cross-sectioned side view of an upper and lower molding representing an embodiment of a concealed joint in a plane including an implementation of a finger guard;

FIG. 8 is a perspective view of a representative embodiment of a sectioned door in a hinged position in a plane including an implementation of a finger guard;

FIG. 9 is a perspective view of a representative embodiment of a framed finger shield joint of a carriage style sectional door;

FIG. 10 is an exploded perspective view of a representative embodiment of the framed finger shield joint of FIG. 9;

FIG. 11 is an exploded, perspective view of the framed finger shield joint end stile of FIG. 10;

FIG. 12 is a perspective, rear view of a representative embodiment of a paneled skin;

FIG. 13 is a cross-sectioned side view of an upper and lower molding representing an embodiment of a framed finger shield joint;

FIG. 14 is an exploded, perspective view of an upper and lower molding representing an embodiment of a framed finger shield joint without stiles;

FIG. 15 is a partially cut away, perspective view of a representative embodiment of a framed finger shield joint detailing the relationship between the various components;

FIG. 16 is a perspective view of a representative embodiment of the sectioned door in a hinged position in a plane including an implementation of a finger shield; and

FIGS. 17A-17W are perspective views of various implementations of the current invention providing a sectional door.

### DETAILED DESCRIPTION OF THE INVENTION

The present invention relates to systems and methods for manufacturing overhead, sectional doors. Specifically, the present invention relates to methods for manufacturing wood style carriage house sectional doors from steel or other metal coil.

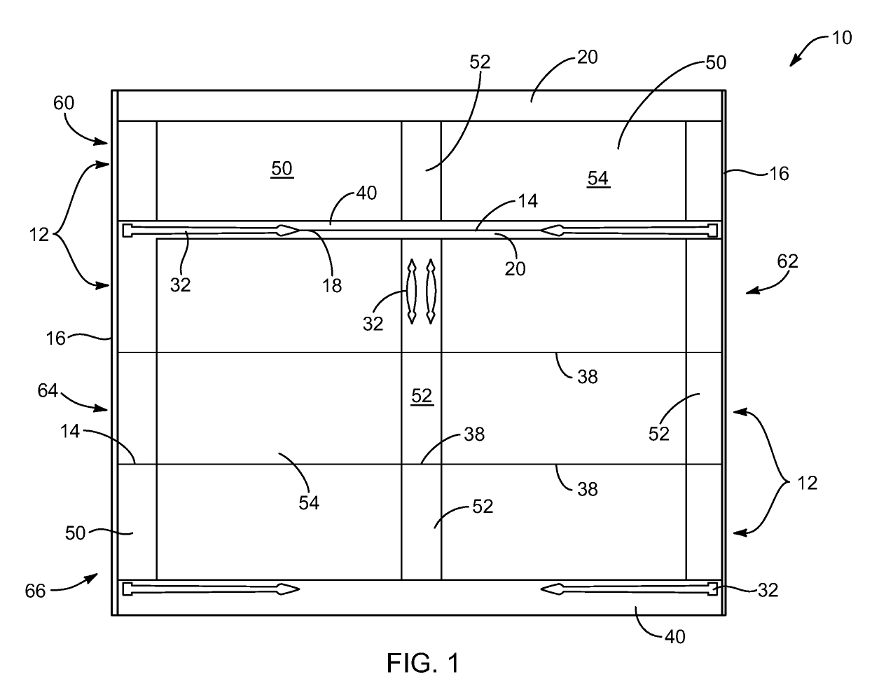

Referring now to FIG. 1, a perspective view of a carriage style sectional door 10 is shown. The sectional door 10 comprises a plurality of sections 12, each section 12 having a length sufficient to span the width of an opening in a building or structure (not shown). For example, the embodiment of FIG. 1 comprises a sectional door 10 having four sections 12. Each section 12 is separately manufactured and then hingedly coupled to another section 12 thereby forming a joint 14 between adjacent sections 12. Each section 12 further comprises a pair of stiles 16. The stiles 16 are generally comprised of sheet metal and are fixedly coupled to the lateral ends of each section 12. The stiles 16 substantially cap the lateral ends of each section and provide a solid, finished surface for the lateral ends capable of accommodating hardware and fasteners necessary for the installment and use of the sectional door 10.

Each section 12 of the door 10 further comprises an upper molding 20, a lower molding 40, and a paneled skin 50. The upper molding 20 and the lower molding 40 act as the horizontal perimeters for each section 12, and the paneled skin 50 provides the structural surface of each section 12. Different upper and lower moldings 20 and 40 are used in conjunction with the paneled skin 50 to achieve a desired aesthetic feature or style. For example, as shown in FIG. 1, a first section 60 comprises an exposed upper and a lower molding 20 and 40 thereby creating a framed appearance for the section 60. Conversely, a second section 62 comprises an exposed upper molding 20 and a concealed lower molding (not shown). As such, the upper molding 20 of the second section 62 combines with the lower molding 40 of the first section to provide a framed finger shield joint 18. Additionally, the concealed lower molding of the second section 62 compliments the concealed upper and lower moldings (not shown) of the third section 64 to create the appearance of one continuous section or aesthetic feature. The concealed moldings of adjacent sections 12 provide a concealed joint 38. The concealed joints 38 between the second, third, and fourth section 62, 64, and 66 combine to create an appearance of one continuous section or aesthetic feature. Thus, the exposed upper molding 20 of the second section 62, and the exposed lower molding 40 of the fourth section 66 combine with the concealed moldings of the second, third, and fourth sections 62, 64, and 66 to create the appearance of a single, unitary section. Specifics regarding the various upper and lower moldings 20 and 40 are discussed in detail below.

The paneled skin 50 comprises a single piece of sheet or coiled metal that has been bent and shaped to comprise a plurality of alternating raised 52 and recessed 54 surfaces. The paneled skin 50 further comprises various surfaces and features to compatibly engage and fixedly attach to the upper and lower molding 22 and 42. Thus, the stiles 16, the upper molding 20 and the lower molding 40 are coupled to the paneled skin 50, thereby framing an outer perimeter of the paneled skin 50 and providing a section 12 of the door 10. Once each section 12 has been separately manufactured, the individual sections 12 are aligned and adjacent moldings 20 and 40 are linked together via hinges to provide the sectional door 10. Additional aesthetic features 32, such as faux hinges and handles, may also be added to the sections 12 to further enhance the cottage-style appearance of the sectional door 10.

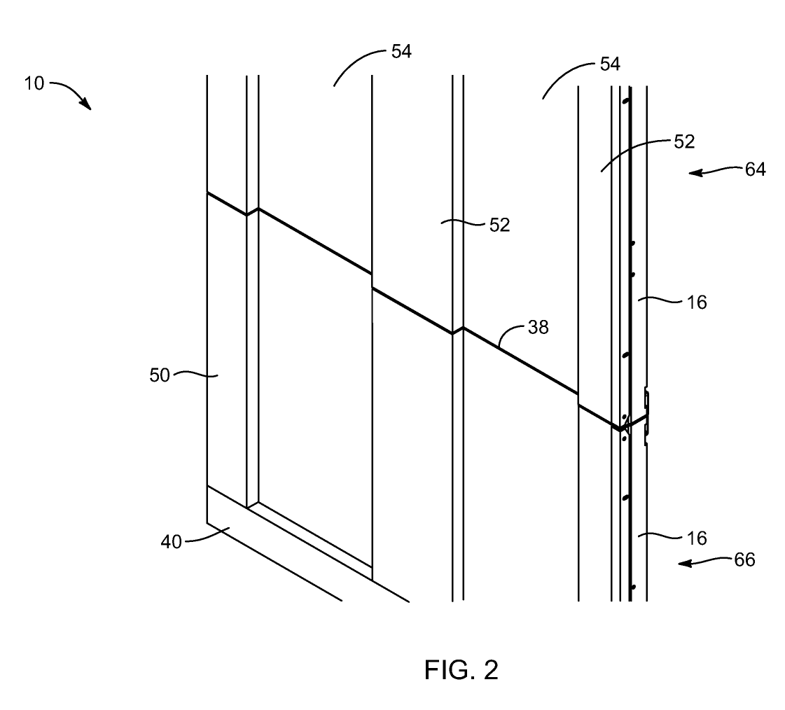

Referring now to FIGS. 2-4, various views of the concealed joint 38 of the third and fourth sections 64 and 66 are shown. In one embodiment, the paneled skin 50 of each section 64 and 66 is bent and shaped to provide identically spaced surfaces 52 and 54. Therefore, when the individual sections 64 and 66 are hingedly coupled, the lines and features of each section 64 and 66 match and provide a uniform appearance. The concealed upper and lower moldings 22 and 42 each comprise a bent and shaped piece of sheet metal that is tooled to the appropriate shape and then cut to a length sufficient to span the width of the sectional door 10. Additionally, the moldings 22 and 42 comprise features and elements to compatibly seat within one another, as well as to compatibly couple to mounting features of the paneled skin 50.

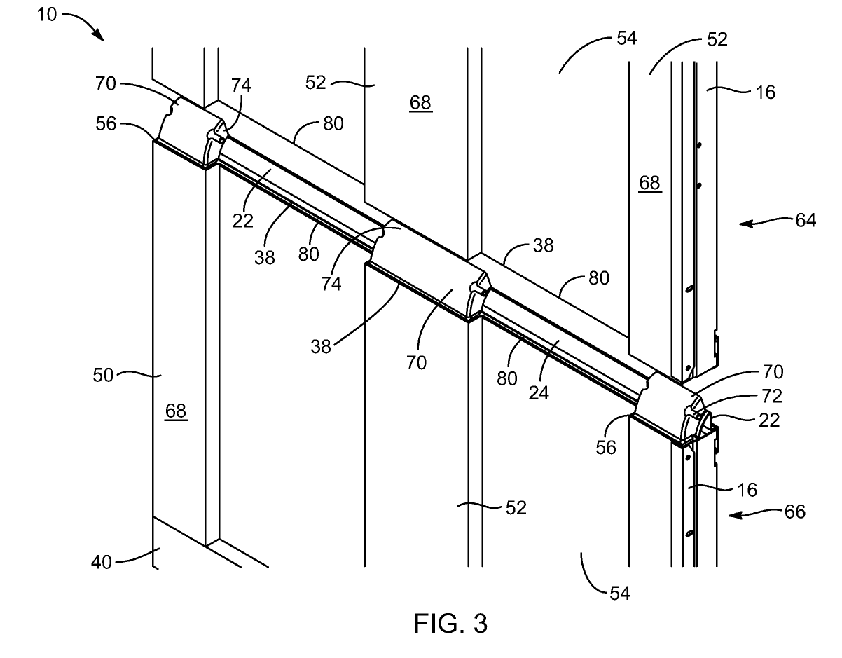

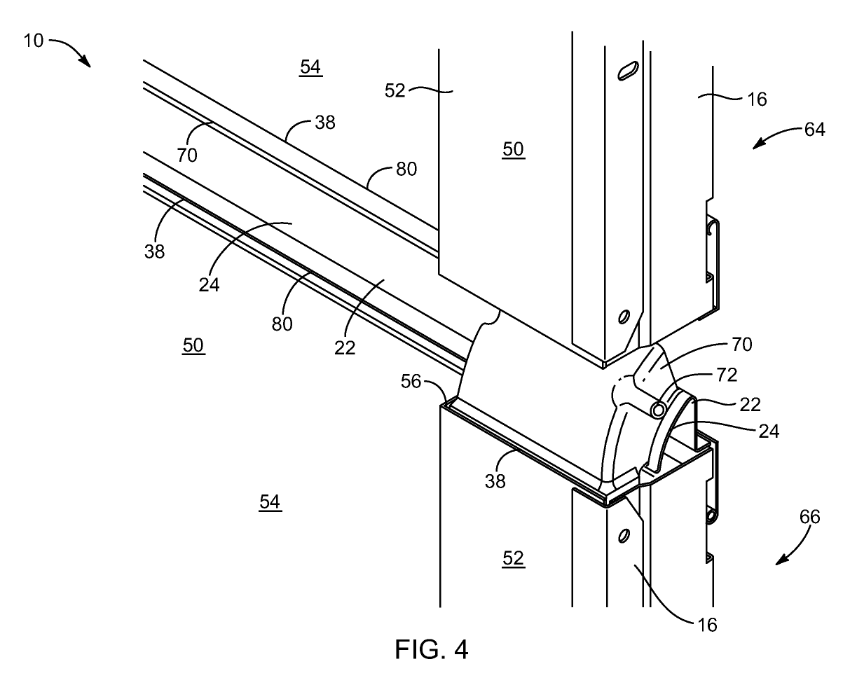

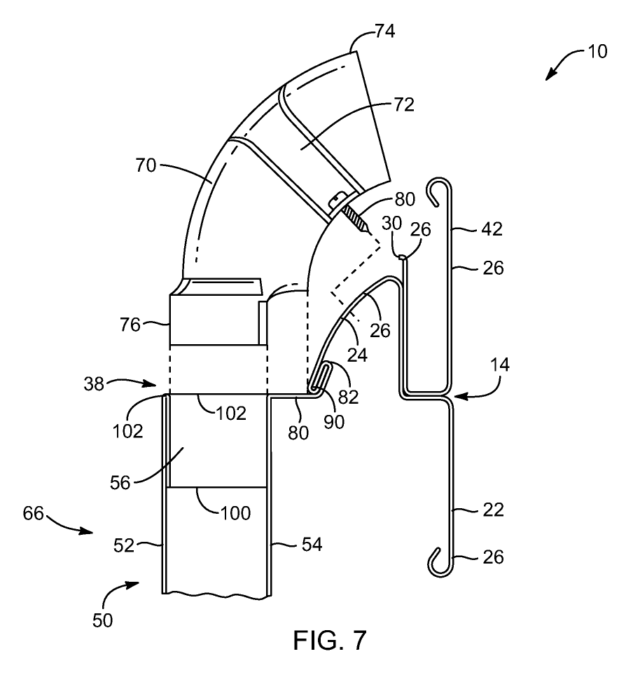

Referring now to FIGS. 3 and 4, exploded views of section 64 and 66 are shown. The raised surfaces 52 of the paneled skin 50 create an aesthetic appearance of raised, vertical panels 68 or moldings that appear to frame the recessed surfaces 54 of the door 10. The raised, vertical panels 68 provide a desirable, vertical board effect that is necessary to reproduce some embodiments of cottage-style doors. Additionally, the raised surfaces 52 or vertical panels 68 provide a cavity 56 into which a finger guard 70 is partially inserted. The finger guard 70 comprises a polymer material and is configured to compatibly seat within the opening of the cavity 56. The finger guard 70 is secured to a contoured surface 24 of the concealed upper molding 22 by any fastening means, such as screws or an adhesive. Where the fastening means is a screw 80, the finger guard 70 is fastened to the concealed upper molding 22 via the mounting channel 72, as shown in FIG. 7.

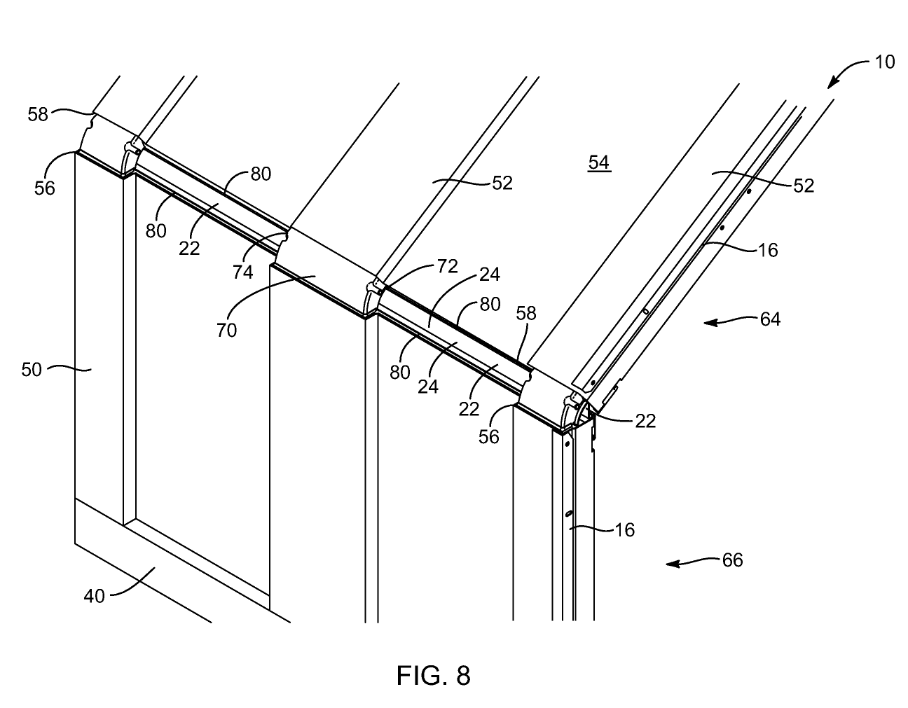

An upper portion 74 of the finger guard 70 is configured to compatibly insert within the cavity 58 of the raised surface 52 of the adjacent section 64. Thus, when the two sections 64 and 66 are hingedly attached, the finger guard 70 prevents insertion of fingers between the opposing raised surfaces 52 of the adjacent sections 64 and 66. This feature is more clearly illustrated in FIG. 8, wherein the third and fourth section 64 and 66 are joined and shown in a hinged position. In addition to preventing insertion of fingers, the finger guard 70 also provides a finished transition between the opposing raised surfaces 52 of each section 64 and 66. In one embodiment, the finger guard 70 is colored to match the color of the door 10. In another embodiment, the finger guard 70 comprises translucent plastic through which the color of the door 10 is displayed.

The concealed upper molding 22 and the concealed lower molding (not shown) are fixedly attached to a portion of the horizontal perimeter edges 80 of the paneled skin's 50 recessed surfaces 54 to provide the required door thickness. For example, in an embodiment where the final thickness of the sectioned door 10 is two inches, the one and one quarter inch wide concealed molding 22 is coupled to the recessed surface 54 of the paneled skin 50 to form the appropriate door thickness of two inches, the raised surface 52 of the paneled skin 50 being three quarters of an inch in depth.

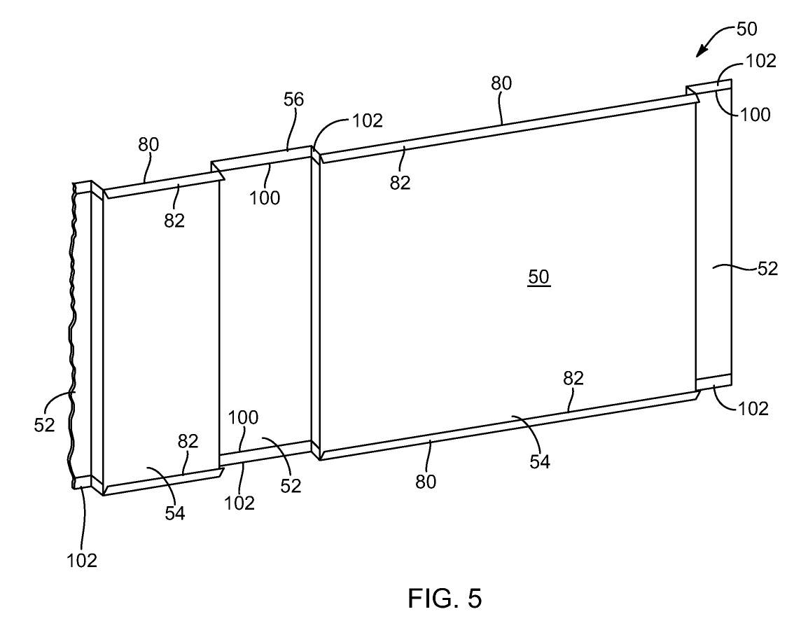

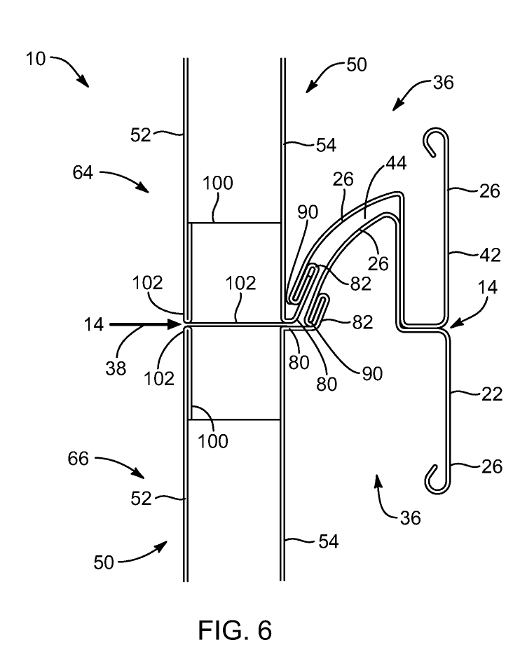

Referring now to FIG. 5, a rear perspective view of the paneled skin 50 is shown. Of particular note are the generally horizontal edges 80 and 100 of the paneled skin 50. The horizontal edges of the paneled skin 50 are cut, shaped and bent to provide various surfaces and features to compatibly engage and fixedly attach the upper and lower molding 22 and 42 of the door 10. For example, the horizontal perimeter edges 80 of the recessed surfaces 54 are bent to provide a lip 82 extending outwardly from the paneled skin 50. The lip 82 provides an elongate, compatible surface to which a mounting channel 90 of the upper and lower concealed moldings 22 and 42 may be coupled and secured, as shown in FIG. 6. Conversely, the perimeter edges 100 of the raised surfaces 52 are folded inwardly, back onto the paneled skin 50 thereby forming a folded edge 102. As such, the folded edge 102 provides a finished opening 56 for the raised surfaces 52 that is aesthetically pleasing and exactly sized to receive the finger guard 70. One of skill in the art will appreciate that the perimeter edges 80 and 100 of the paneled skin 50 may be bent and shaped to any configuration to permit successful coupling of the paneled skin 50 to the other components 50, 16, 22 and 24 of the door 12 assembly.

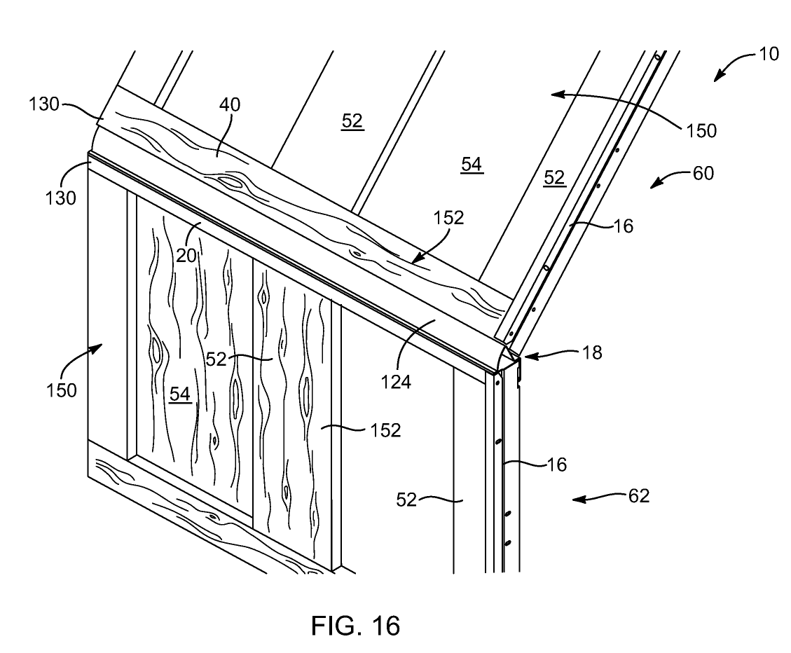

Referring now to FIG. 6, a cross-sectional side view of the concealed joint 38 is shown without the finger guard, more clearly showing the relationship between the paneled skin 50 and the upper and lower concealed moldings 22 and 42. Each molding 22 and 42 comprises a backing flange 26, a mating surface 28, and a mounting channel 90. The backing flange 26 extends upwardly from the joint 14 of the sections 64 and 66, and is generally parallel to the plane of the paneled skin 50. A gap 36 is provided between the backing flange 26 and the paneled skin 50 to allow placement of insulation or another backing material within the door 10. The upper concealed molding 22 is further configured to compatibly seat within a receiving channel 44 of the lower concealed molding 42. Thus, the receiving channel 44 of the lower molding 42 and the contoured surface 24 of the upper molding 22 form mating surfaces 26 to prevent unwanted passing of wind and moisture through the joint 38. The contoured surface 24 further provides a finger shielding feature for preventing insertion of fingers or other items within the joint 14, more clearly shown in FIGS. 8 and 16 below.

The concealed moldings 22 and 42 each further include a mounting channel 90. The mounting channels 90 are u-shaped bends that form a terminal end of the moldings 22 and 42 opposite the backing flanges 26. The mounting channels 90 compatibly engage the lip 82 of the recessed surfaces 54 and are further rolled together and pressed to achieve coupling between the paneled skin 50 and the moldings 22 and 42. This coupling may include any method of metal joining, including hemming, seaming, welding, spot welding, riveting, crimping, and use of an adhesive. For example, in one embodiment the lip 82 is seated within the mounting channel 90 and then the mounting channel 90 and lip 82 are pressed to form a hemmed seam. As such, the coupling between the mounting channels 90 and the lip 82 create a weather tight seal as required by sectional garage doors.

Referring now to FIG. 7, an exploded, cross-sectional side view of the bottom half of the concealed joint 38 is shown in a plane including the finger guard 70. A base portion 76 of the finger guard 70 is configured to compatibly fit within the opening 56 of the raised surface 52. The finger guard 70 is further accommodated by removing a portion of the mating surface 26 of the lower concealed molding 42, which portion corresponds to the placement of the finger guard 70. The removed portion of the lower molding 42 creates a gap or window 30 in the molding 42 that is filled by the inserted finger guard 70. Finally, the finger guard 70 is secured to the contoured surface 24, or mating surface 26 of the upper concealed molding 22 via a screw 80 through the mounting channel 72, or by another appropriate fastening means, as previously discussed.

Referring now to FIG. 8, the third and fourth sections 64 and 66 are shown in a hinged position. As previously discussed, the hingedly coupled sections 64 and 66 are combined with the inserted finger shields 70 to provide the aesthetic appearance of continuous panels running between the separate sections 64 and 66. Furthermore, the contoured surface 24 of the upper concealed molding 22 and the contoured surface of the finger guard 70 permit the sections 64 and 66 to hingedly flex but prevent fingers or other items from being inserted there between. Thus, the concealed joint 38 is aesthetically pleasing and a functional safety element of the sectional door 10.

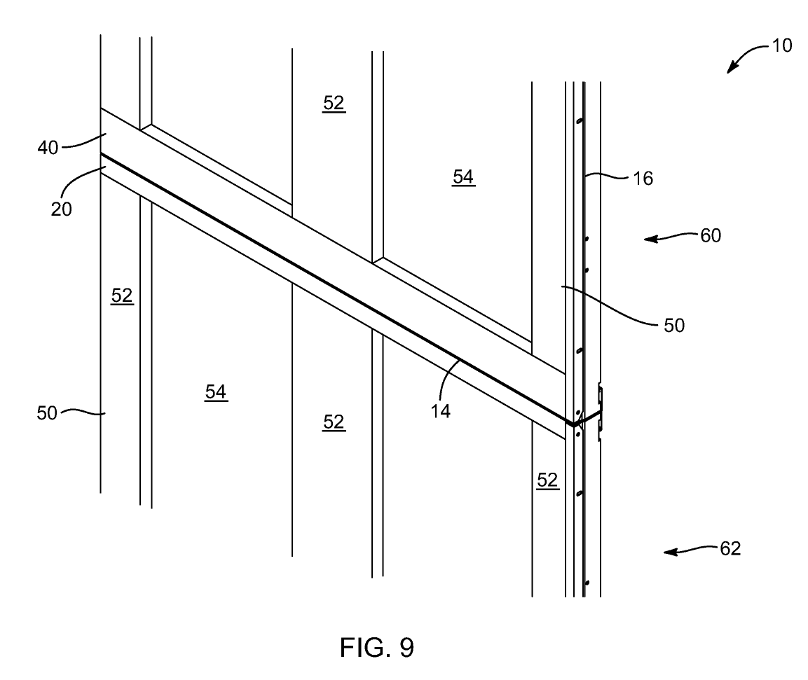

Referring now to FIGS. 9-11, various views of the framed finger shield joint 18 of the first and second sections 60 and 62 are shown. As with the paneled skins 50 of the third and fourth sections 64 and 66, the paneled skins 50 of the first and second sections 60 and 62 are bent and shaped to provide identically spaced surfaces 52 and 54. Again, the raised 52 and recessed 54 surfaces of the paneled skin 50 create an aesthetic appearance of a carriage style paneled door. However, unlike the third and fourth section 64 and 66 previously discussed, the upper 20 and lower 40 moldings of the first and second 60 and 62 sections are exposed and visually divide the sections 60 and 62 from one another. As such, the framed finger shield joint 18 and the raised surfaces 52 visually combine to frame the recessed surfaces 54 of the sections 60 and 62. Therefore, by selectively using concealed and exposed moldings, a wide variety of aesthetic configurations can be achieved. For example, in one embodiment a sectional door 10 is provided utilizing a plurality of concealed and framed finger shield joints to create an aesthetically pleasing, carriage style sectional door 10.

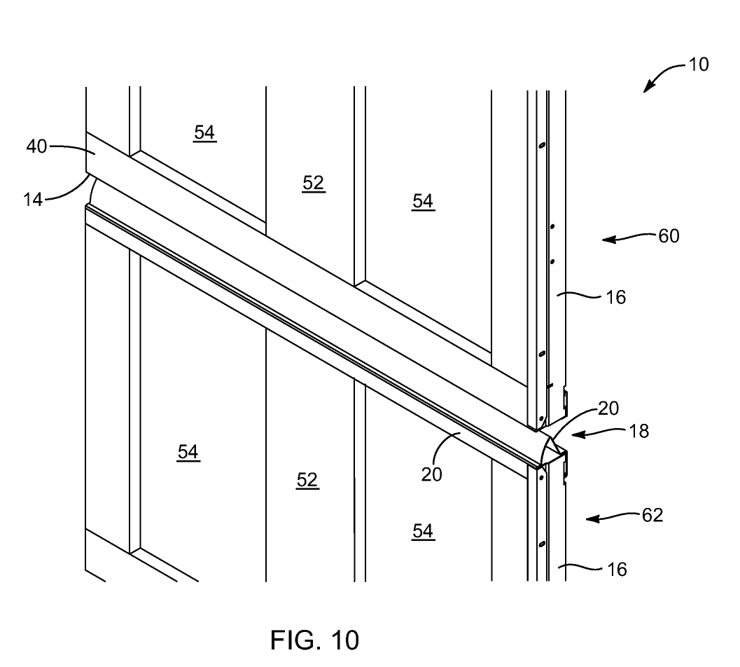

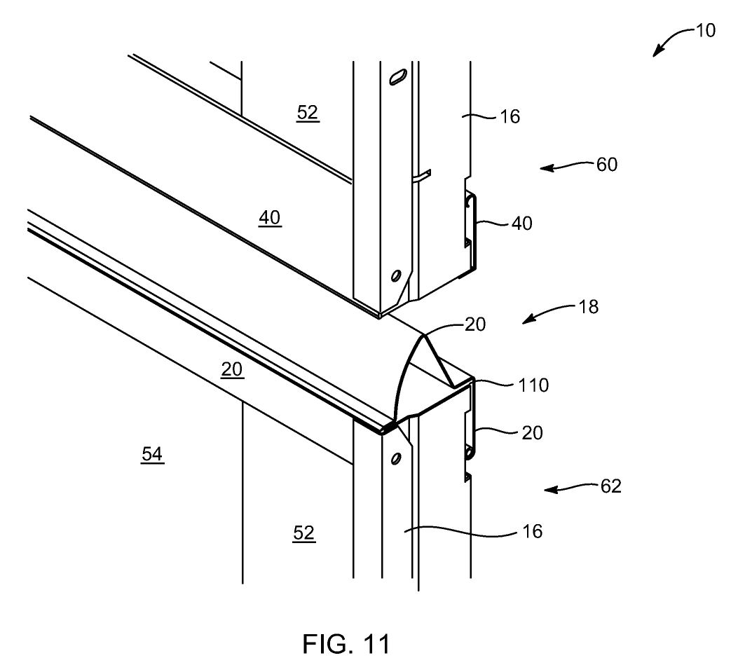

Referring now to FIGS. 10 and 11, exploded views of section 60 and 62 are shown. The upper molding 20 and the lower molding 40 each comprises a bent and shaped piece of sheet metal that is tooled to the appropriate shape and then cut to a length sufficient to span the width of the sectional door 10. The upper and lower moldings 20 and 40 are then fixedly attached to the perimeter edges 110 of both the raised 52 and recessed 54 surfaces. Therefore, in one embodiment where the final thickness of the sectioned door 10 is two inches and the width of the paneled skin 50 is three-quarter of an inch, the raised 52 and recessed 54 surfaces of the paneled skin 50 are coupled to a two inch wide exposed molding 40 to form the desired door thickness of two inches. Unlike the concealed moldings 22 and 42, the exposed upper and lower moldings 20 and 40 comprise the complete interface surface between the adjacent sections 60 and 62 and therefore do not require finger guards or other protective hardware in addition to the moldings 20 and 40.

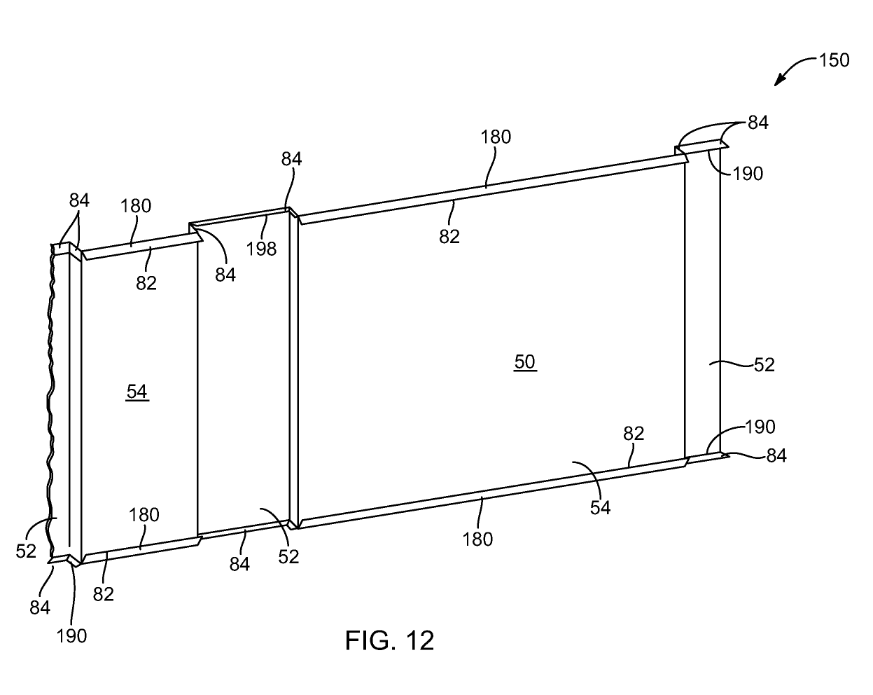

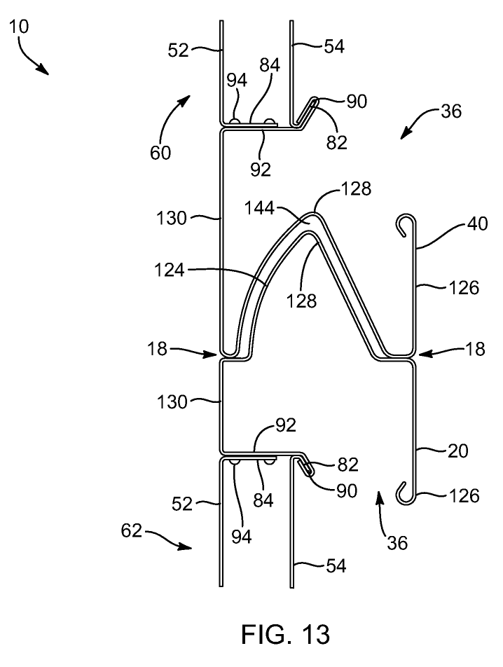

Referring now to FIG. 12, a rear perspective view of the paneled skin 150 is shown. Of particular note are the generally horizontal edges 180 and 190 of the paneled skin 150. The horizontal edges of the paneled skin 150 are cut, shaped and bent to provide various surfaces and features to compatibly engage and fixedly attached the upper and lower moldings 20 and 40 of the door 10. For example, the horizontal perimeter edges 180 of the recessed surfaces 54 are bent to provide a lip 82 extending outwardly from the paneled skin 150. The lip 82 provides an elongate, compatible surface to which a mounting channel 90 of the upper and lower moldings 20 and 40 may be coupled and secured, as shown in FIG. 13. Conversely, the perimeter edges 190 of the raised surfaces 52 are cut and bent to approximately 90° relative to the paneled skin 150. As such, the perimeter edges 190 form a plurality of flanges 84 to which a mounting surface 92 of the upper and lower moldings 20 and 40 is attached. As such, the paneled skins 150 and the moldings 20 and 40 are compatibly and permanently coupled to provide an aesthetically pleasing carriage style sectional door.

Referring now to FIG. 13, a cross-sectional side view of the framed finger shield joint and attached paneled skins 150 is shown. Each molding 20 and 40 is generally an opened box shape and comprises a backing flange 126, a mating surface 128, a mounting channel 90, a mounting surface 92, and a face surface 130. The backing flange 126 extends upwardly from the framed finger shield joint 18 and is generally parallel to the plane of the paneled skin 150. A gap 36 is provided between the backing flange 126 and the paneled skin 150 to allow placement of insulation or another backing material within the door 10. The upper molding 20 is further configured to compatibly seat within a receiving channel 144 of the lower molding 40. Thus, the receiving channel 144 of the lower molding 40 and the contoured surface 124 of the upper molding 20 form mating surfaces 26 to prevent unwanted passing of wind and moisture through the joint 18.

The moldings 20 and 40 each further include a mounting channel 90. The mounting channels 90 are configured and operate in an identical manner to the mounting channels previously discussed in connection with the concealed moldings 22 and 42, above. However, the mounting channels 90 of the upper and lower moldings 20 and 40 are not directly attached to the mating surface of the moldings, but rather are directly attached to the mounting surfaces 92 of the moldings 20 and 40. The mounting surface 92 comprise a short, linear length of molding that is perpendicular to and directly attached to the face surface 130 of the molding 20 and 40. The mounting surface 92 is positioned so as to align with the flange 84 features of the raised surfaces 52. As such, the flange 84 and the mounting surface 92 are coupled together via a rivet 94, a metal punch, or another fastening means, such as spot welding or an adhesive. As configured, the coupling of the flange 84 and the mounting surface 92, as well as the coupling of the lip 82 and the mounting channel 90 effectively join the paneled skin 150 and the moldings 20 and 40 to provide stylized sectional door 10 sections. Additionally, the coupling between the compatible features creates a weather tight seal as required by sectional garage doors.

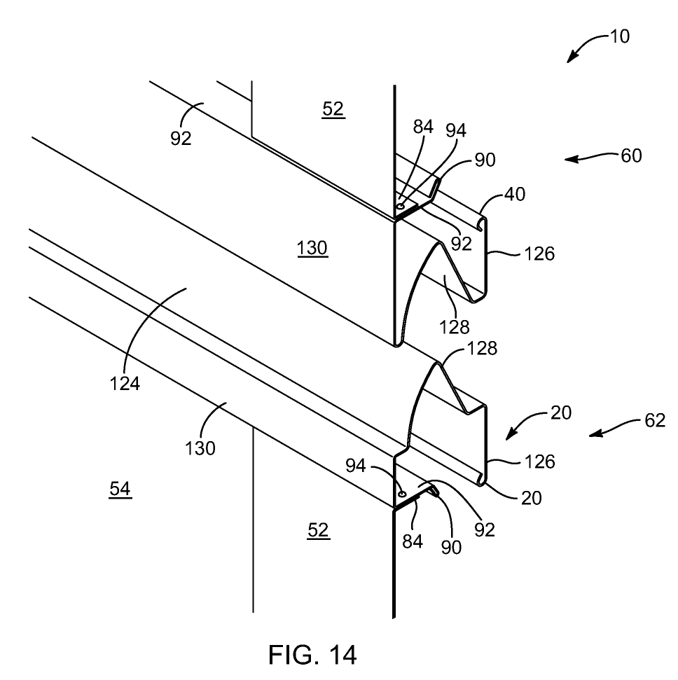

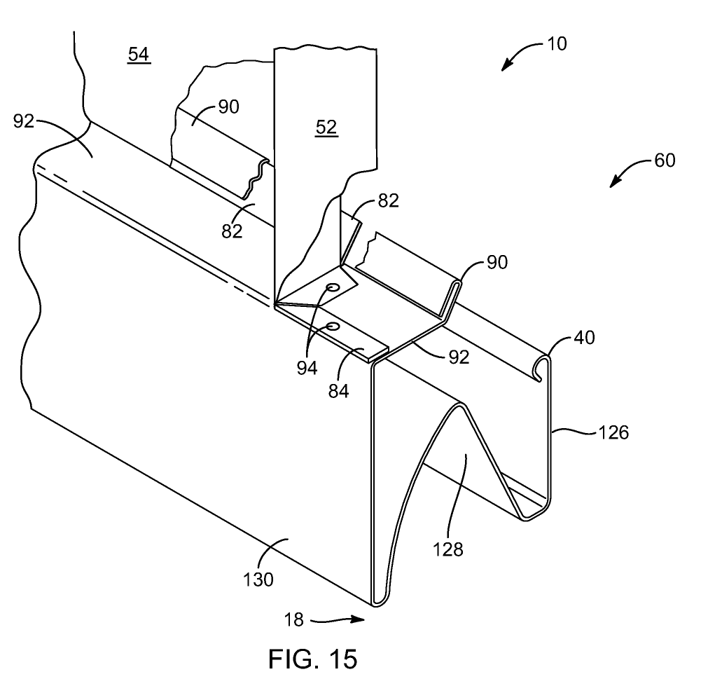

Referring now to FIGS. 14 and 15, various detailed views of the sectional door 10 are shown. Specifically, FIGS. 14 and 15 more clearly illustrate the relationship between the paneled skin 150, the mounting channel 90 and the lip 82, and the flange 84 and the mounting surface 92. Referring now to FIG. 14, an exploded, perspective view of FIG. 13 is shown. Of particular note is mounting surface 92. Specifically, the relationship between the paneled skin 150 and the moldings 20 and 40 results in mounting surface 92 intermittently being concealed and exposed across the sections 60 and 62. For example, where the paneled skin 150 is raised 52, the mounting surface 92 is concealed and riveted or otherwise attached to the flange 84 of the skin 150. Additionally, where the paneled skin 150 is recessed 54, the mounting surface 92 is exposed visually as ledge of a raised or outwardly extending molding or framing surface. Furthermore, where the paneled skin 150 is recessed 54, a mounting channel 90 of the molding 20 and 40 is coupled with a lip portion 82 of the skin 150 and pressed to further couple the paneled skin 150 and the moldings 20 and 40, as shown in FIG. 15. This intricate configuration provides an aesthetically pleasing and customizable carriage house style sectional door that overcomes the difficulties associated with current carriage house style doors.

Referring now to FIG. 16, the first and second sections 60 and 62 are shown in a hinged position. As previously discussed, the raised and recessed surfaces 52 and 54 of the paneled skin 150, along with the upper and lower moldings 20 and 40 are provided to create an aesthetically pleasing and accurate carriage style sectional door 10. In addition to being aesthetically pleasing, the contoured surface 124 of the upper molding 20 permit the sections 60 and 62 to hingedly flex but prevent fingers or other objects from being inserted therebetween. Thus, the framed finger shield joint 18 is aesthetically pleasing and a functional safety element of the sectional door 10.

The sectional door 10 may include other features or details to further enhance the aesthetic quality of the door 10. For example, in one embodiment the materials of the paneled skin 150 and the moldings are embossed with a pattern or design 152. In one embodiment the embossing 150 is a wood grain pattern to simulate a wood material. In another embodiment the embossing 150 is a geometric shape, such as a pattern of parallel grooves or a corrugated pattern. In yet another embodiment, a paint and/or texture is added to the paneled skin 150 and the moldings 20 and 40 to simulate a material or style.

The process for fabricating the sectioned door 10 may be accomplished by any known method or methods of sheet metal fabrication and tooling. One advantage of some implementations of the current invention is that the process for fabricating the sectioned door 10 may be automated and requires a minimal number of parts. For example, in one embodiment a carriage style sectional door is fabricated by first cutting a 24 or 26 gauge piece of sheet metal into three pieced, the dimensions of each piece corresponding to one of a paneled skin, an upper molding, or a lower molding. Each piece is then run through a sheet metal tooling device to cut, bend, and shape each piece to achieve the required contours, surfaces, and features as discussed in detail above. Next, a first molding and the paneled skin are abutted along a common edge and ran through a second sheet metal tooling device that folds, hems, presses and/or rivets the necessary surfaces of the two pieces. Finally, the second molding and the paneled skin are abutted along a second common edge and ran through the second sheet metal tooling device to likewise attach the second molding and the paneled skin. Additional steps may include attaching the stiles, cutting windows along the moldings to accommodate the finger shields and/or hinges, and embossing and painting the various pieces as desired.

Thus, embodiments of the present invention relate to systems and methods for manufacturing overhead, sectional doors. Specifically, the present invention relates to methods for manufacturing wood style carriage house sectional doors from steel or other metal coil.

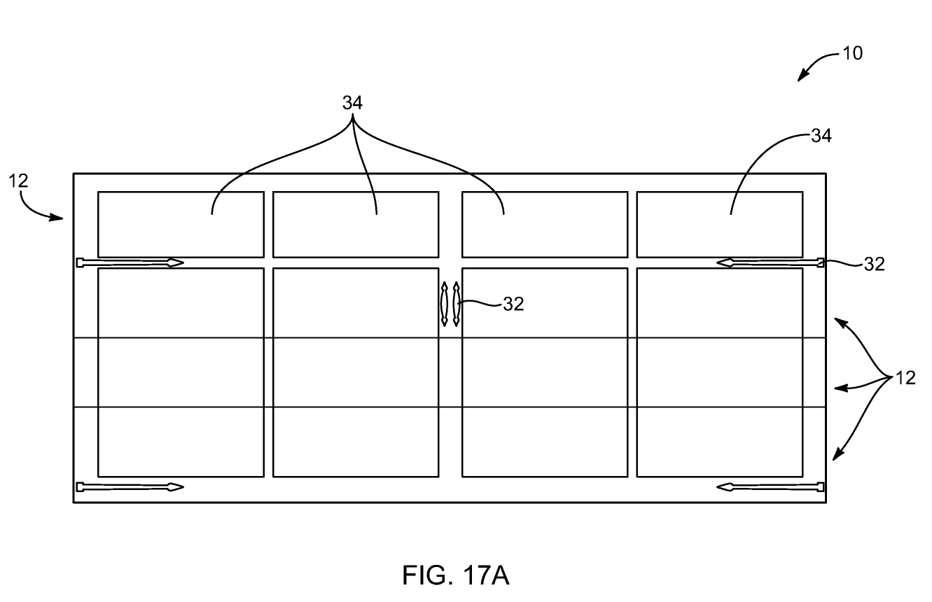

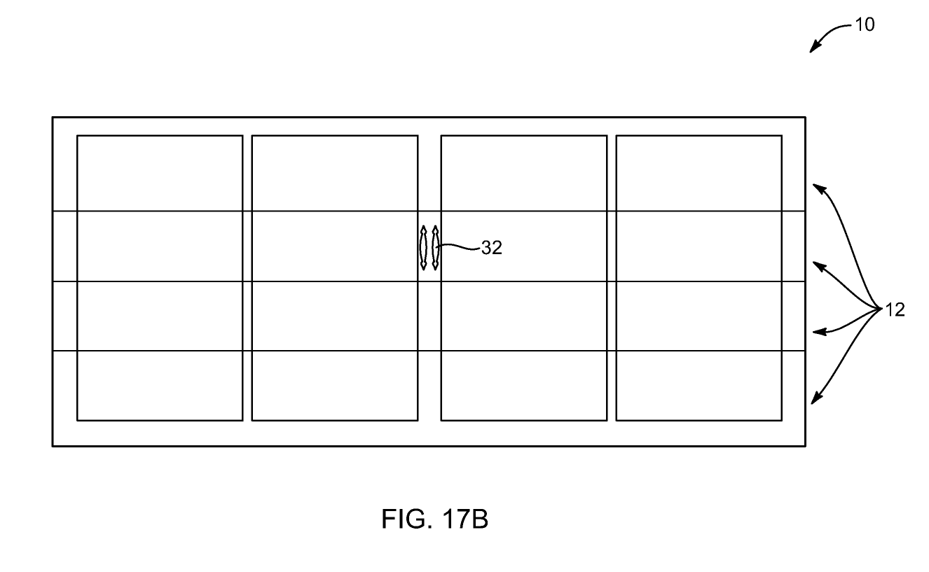

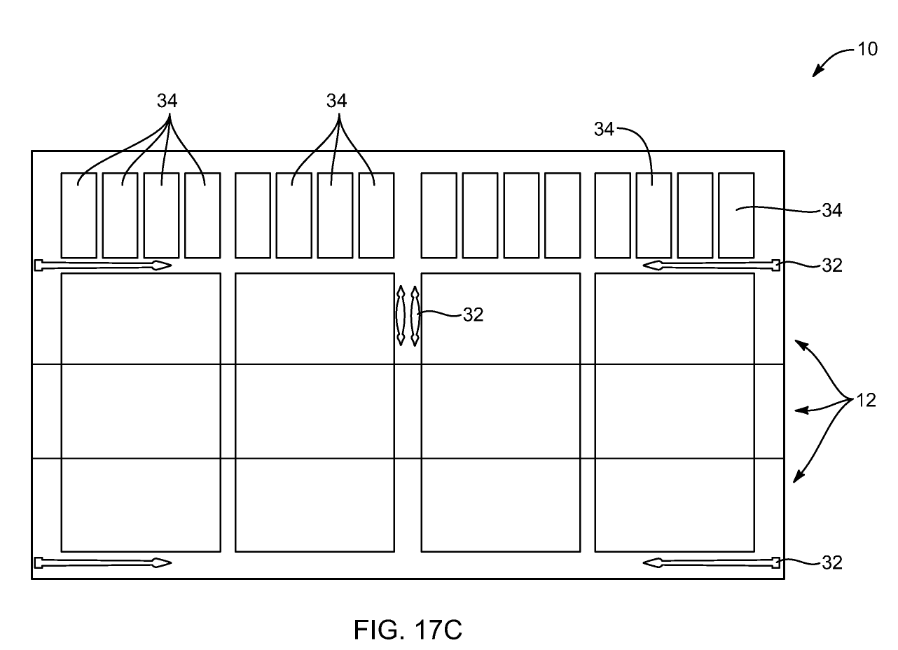

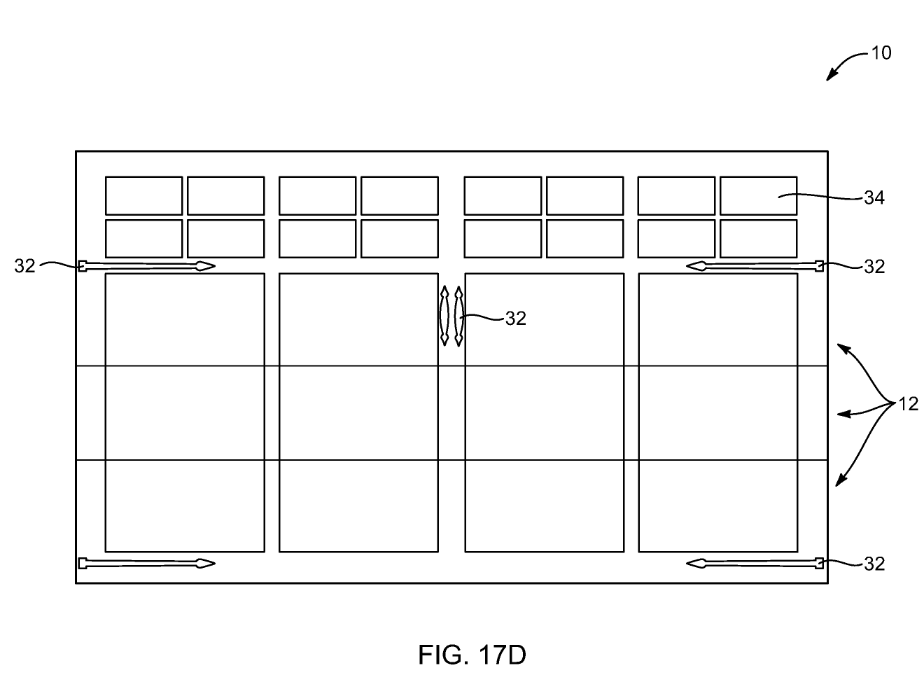

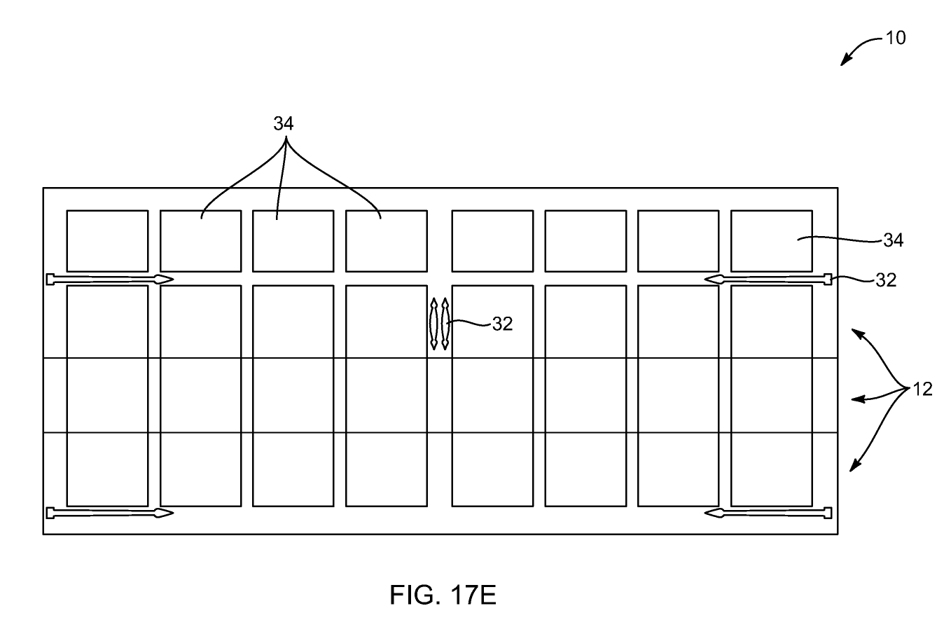

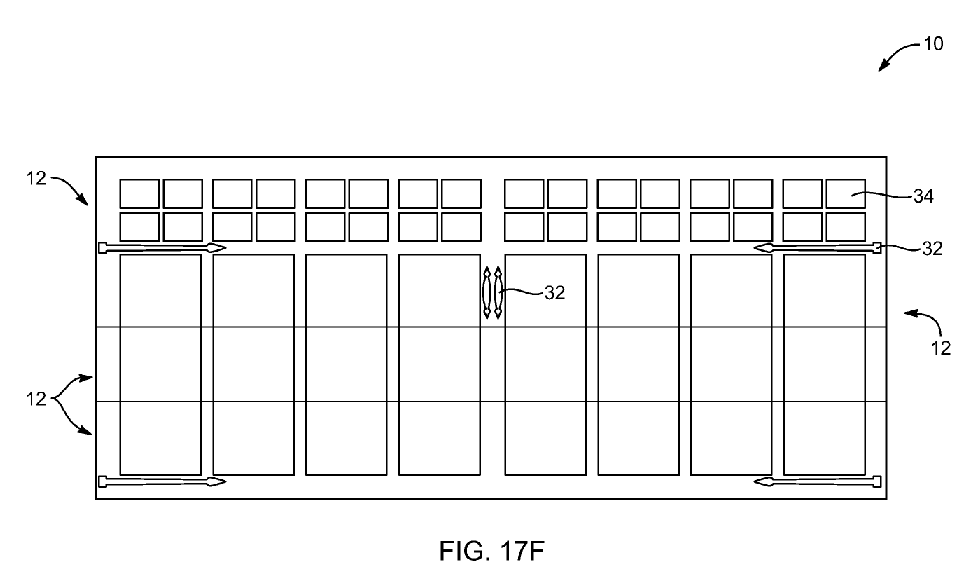

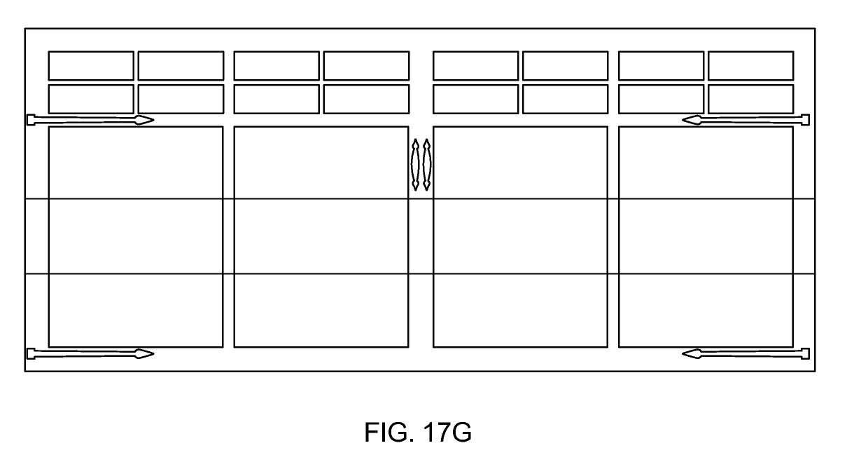

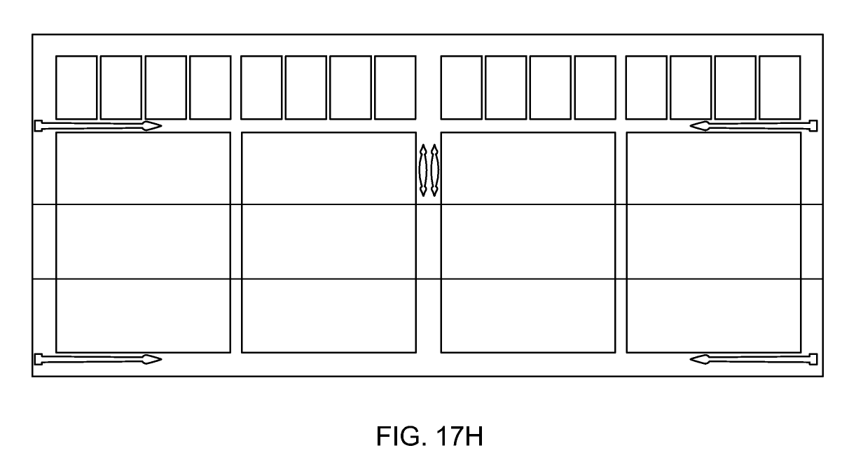

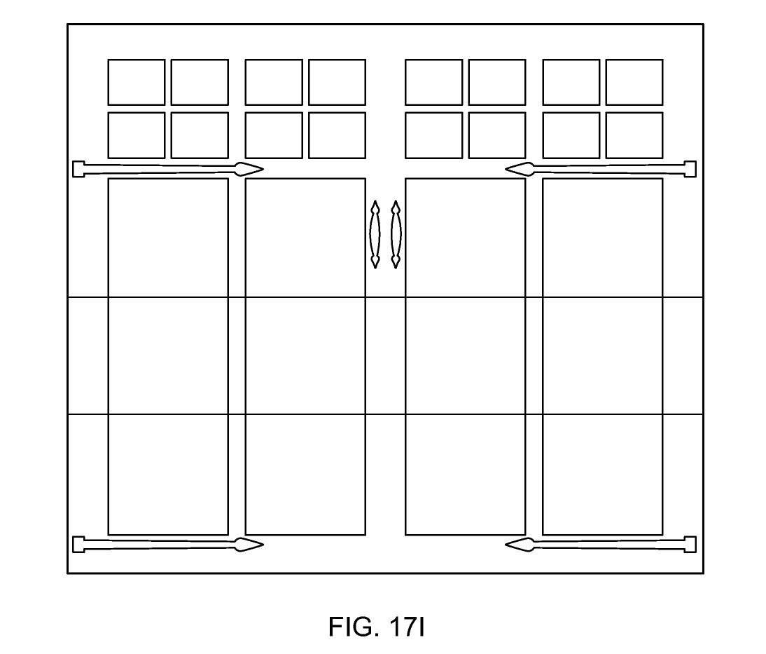

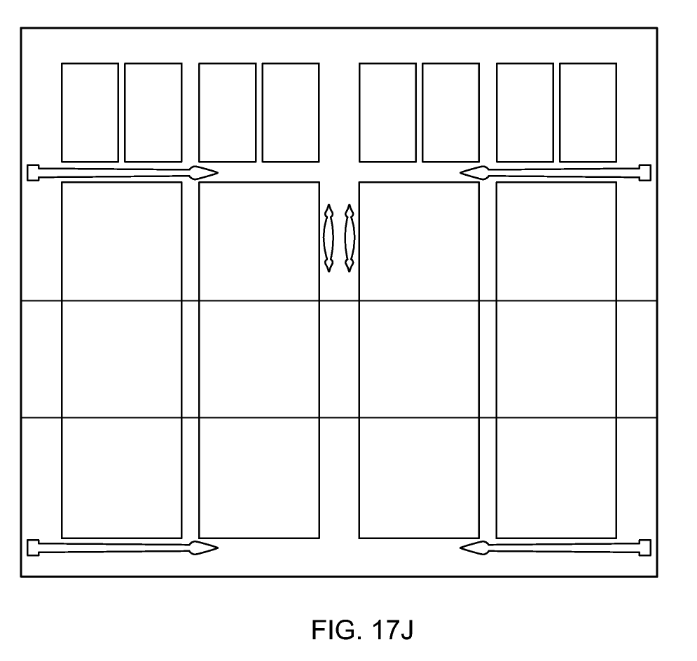

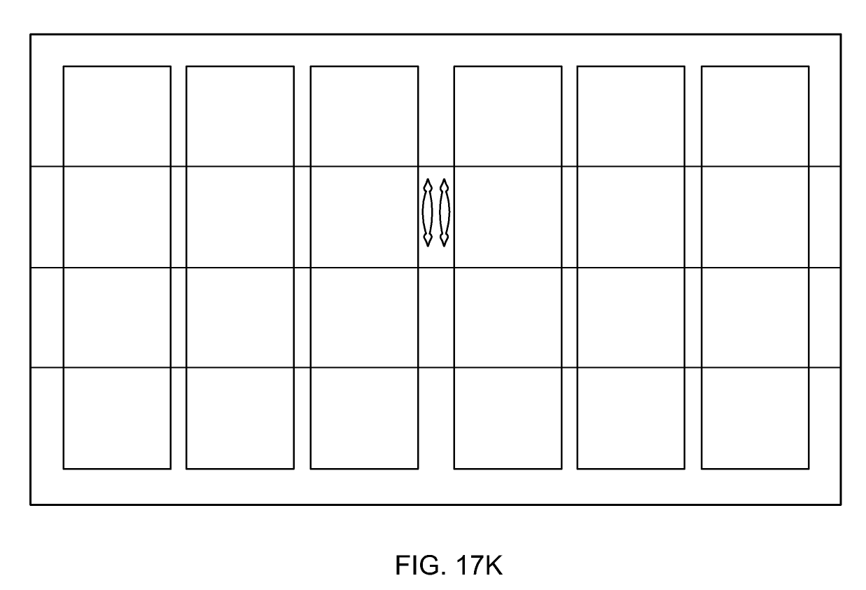

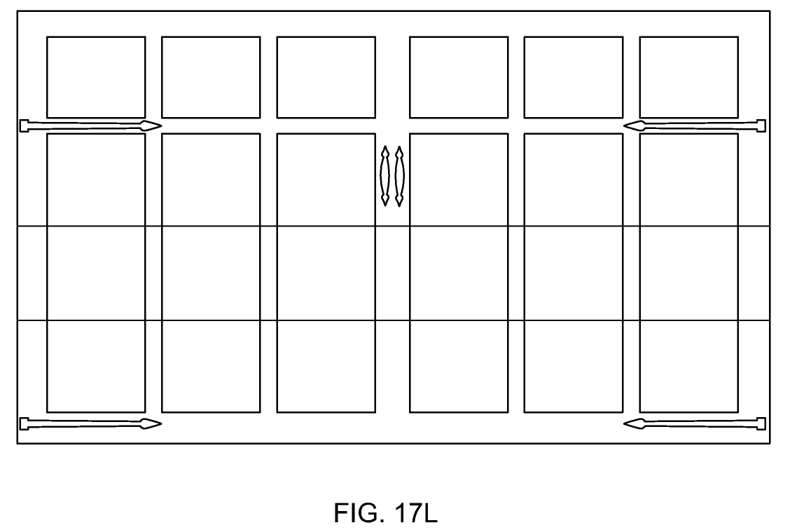

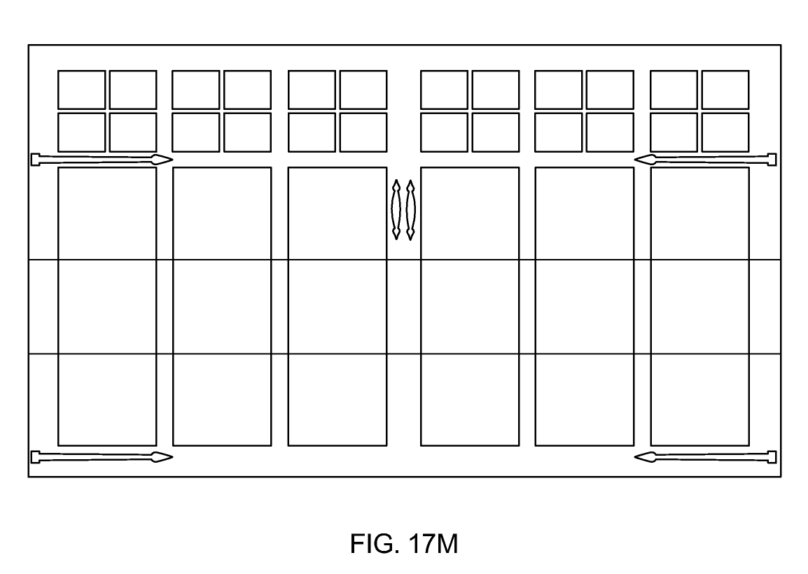

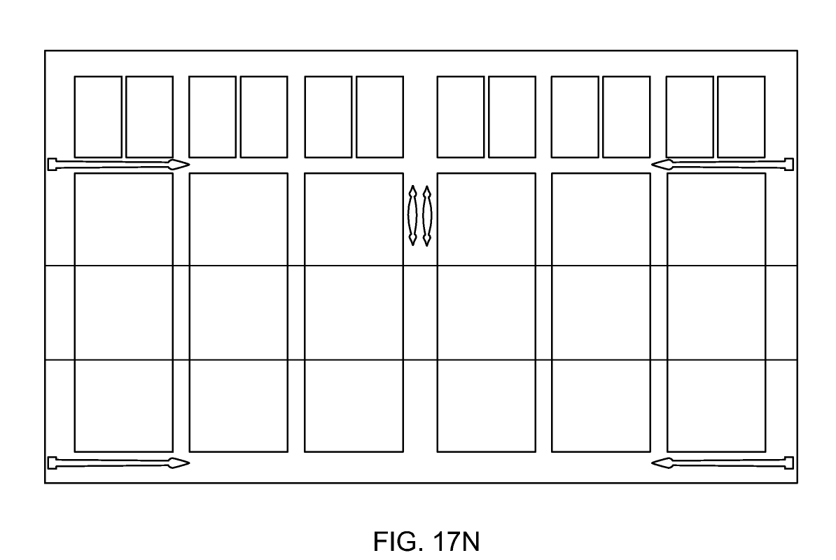

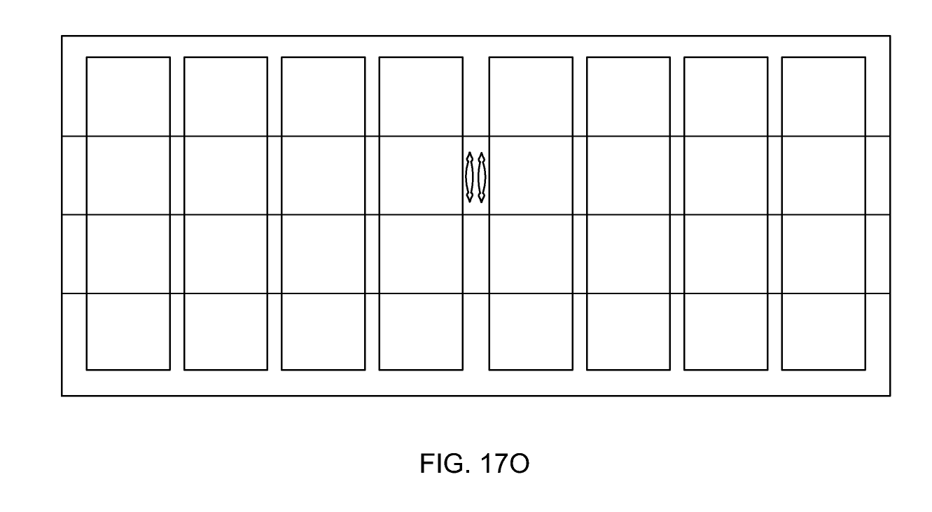

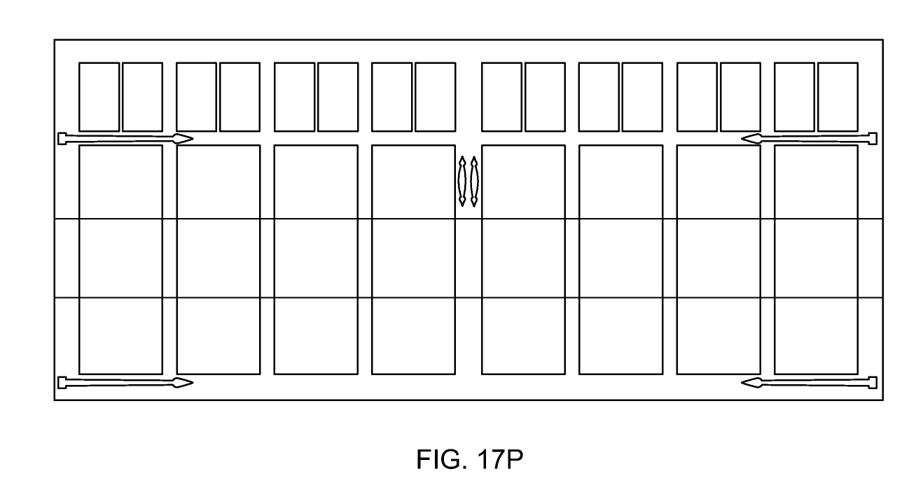

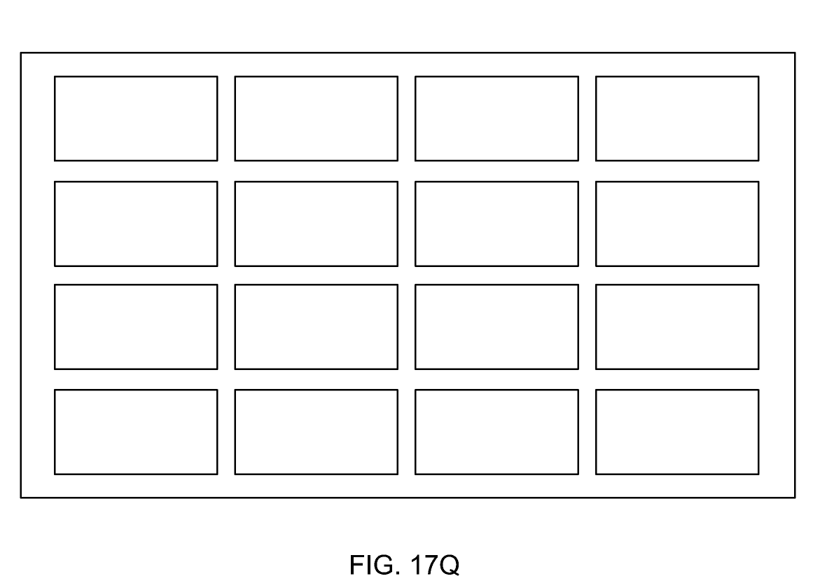

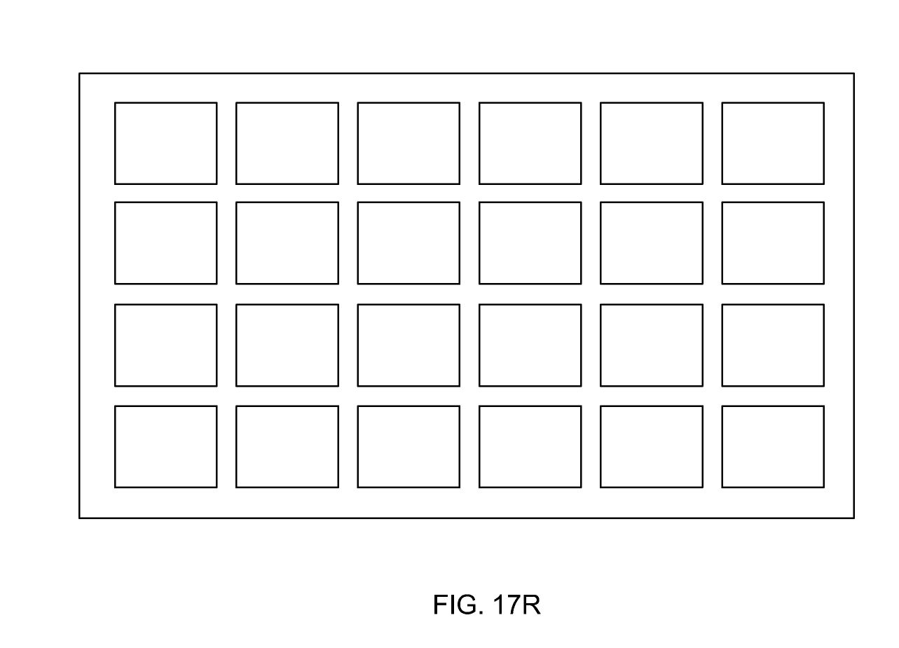

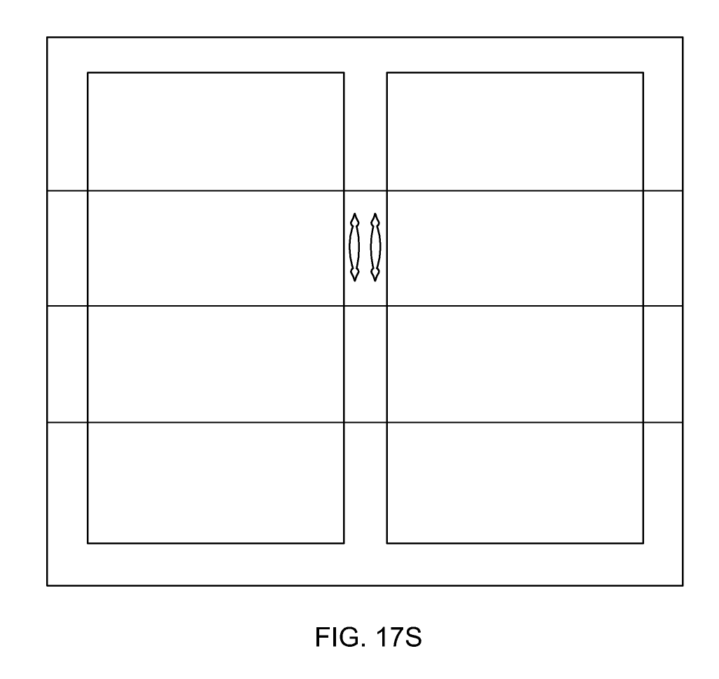

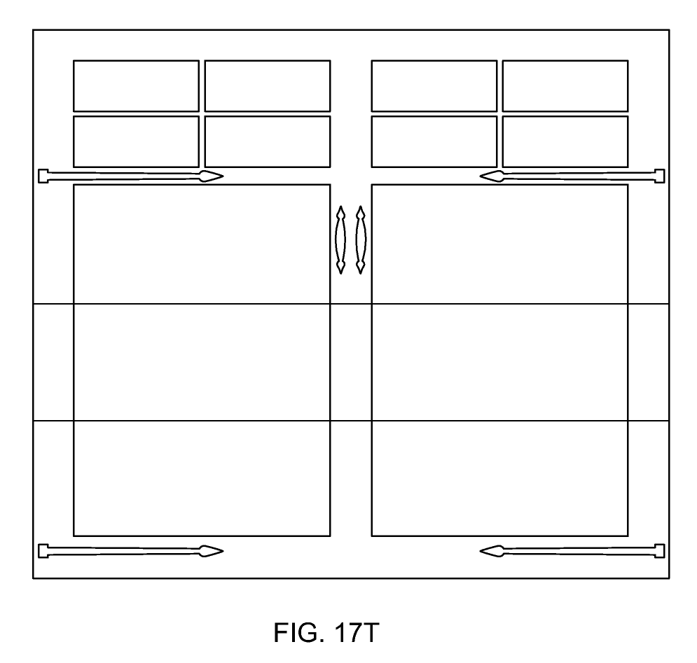

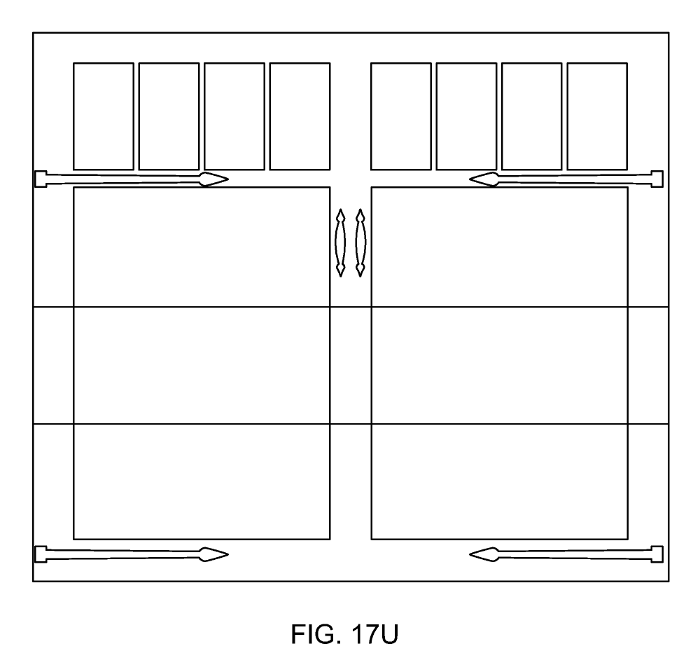

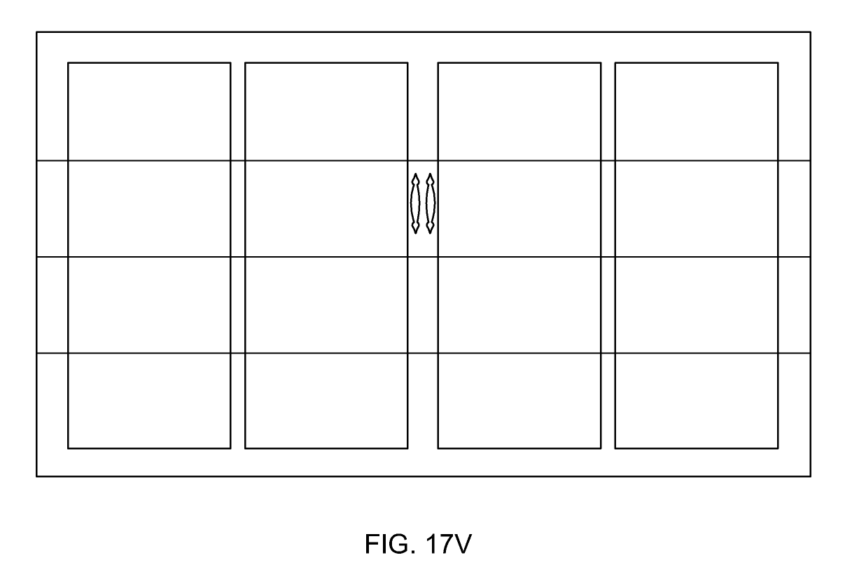

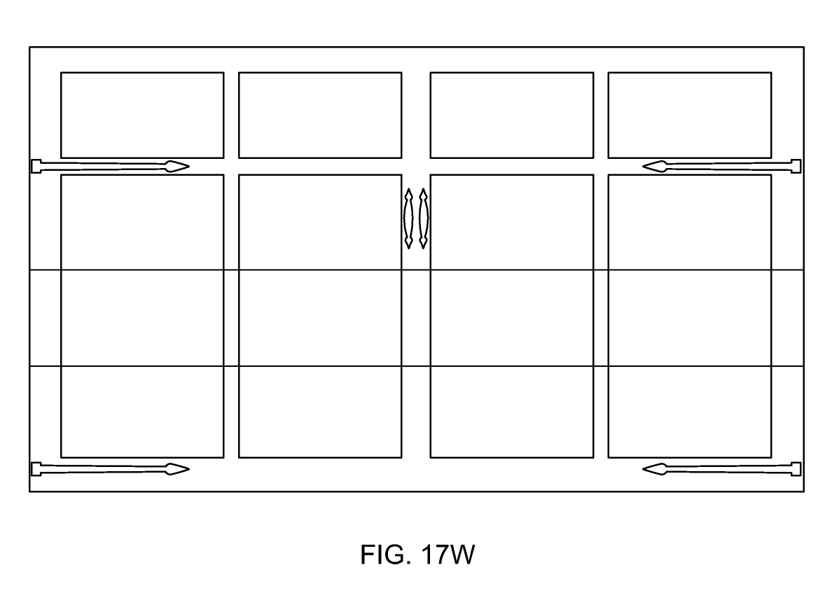

Referring now to FIGS. 17A-17W, various embodiments of the sectional door 10 are shown. As illustrated, various embodiments of the sectional door 10 may include various styles of windows 34 and other ornamental features 32. The versatility of the current invention permits incorporation of a plurality of designs and ornamental features into the final sectional door. As such, the sectional door 10 of the current invention is highly customizable and therefore may be easily designed to achieve a desired aesthetic appearance and functionality.

The present invention may be embodied in other specific forms without departing from its structures, methods, or other essential characteristics as broadly described herein and claimed hereinafter. The described embodiments are to be considered in all respects only as illustrative, and not restrictive.

For example, one of skill in the art will appreciate that additional features, such as windows, stained glass, and iron works may be easily incorporated into the current methods and are anticipated within the scope of the present invention. Additionally, one of skill in the art will appreciate that any section of the sectional door can be modified to include additional features, such as windows. The scope of the invention is, therefore, indicated by the appended claims, rather than by the foregoing description. All changes that come within the meaning and range of equivalency of the claims are to be embraced within their scope.

What is claimed is:

1. A method for manufacturing a metal carriage door, the method comprising:
forming a first molding having a first mounting surface and a first mounting channel;
forming a second molding having a second mounting surface and a second mounting channel;
shaping a piece of sheet metal into a paneled skin having a first end and a second end, the paneled skin further comprising a recessed surface and a raised surface, a portion of the recessed surface having a lip for engaging the first and second mounting channels, and a portion of the raised surface having a flange for abutting the first and second mounting surfaces; and
assembling the metal carriage door, the process of assembly comprising:
inserting the lip of the first end into the first mounting channel;
abutting the flange of the first end to the first mounting surface;
inserting the lip of the second end into the second mounting channel;
abutting the flange of the second end to the second mounting surface;
securing the lip within the first and second mounting channels; and
securing the flange to the first and second mounting surfaces.
